(19) United States
(12) Patent Application Publication
(10) Pub. No.: US 2024/0203435 A1
(43) Pub. Date: Jun. 20, 2024

(54) INFORMATION PROCESSING METHOD, APPARATUS AND COMPUTER PROGRAM

(71) Applicant: Sony Interactive Entertainment Inc., Tokyo (JP)

(72) Inventors: Philip Cockram, London (GB); Michael Eder, London (GB); Nicola Penny Ann Cavalla, London (GB)

(73) Assignee: Sony Interactive Entertainment Inc., Tokyo (JP)

(21) Appl. No.: 18/535,011

(22) Filed: Dec. 11, 2023

(30) Foreign Application Priority Data
Dec. 20, 2022 (GB) 2219262.9

(51) Int. Cl. G10L 21/00; G10L 15/02; G10L 25/60

(52) U.S. Cl. CPC G10L 21/00; G10L 15/02; G10L 25/60

(57) ABSTRACT

An information processing method, of generating corrected audio content in which a portion of first audio content has been corrected, comprises acquiring first audio content from an audio receiving device, identifying a target portion of the first audio content having a predetermined characteristic, selecting correction processing to be performed on the target portion of the first audio content in accordance with the predetermined characteristic of the target portion, and generating corrected audio content in which the target portion of the first audio content has been corrected by performing the selected correction processing on the target portion of the first audio content.

### BACKGROUND

### Field of the Disclosure

The present invention relates to an information processing method, apparatus and computer program.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Information processing apparatuses are now used in a wide variety of situations. For example, an information processing apparatus may be used as part of an entertainment system. Information processing apparatuses are also used in many other types of situations and environments (e.g. in a hospital, in an office, in a vehicle and the like).

In order to control an information processing apparatus, a user must provide an input command or instruction. Input commands or instructions can be provided by a user with a number of different types of input devices. One type of input device is an audio device (such as a microphone) which captures audio (sounds, speech or the like) provided by the user. This enables a user to use audio to provide input commands or instructions to control an information processing apparatus. A user can also use audio (sounds, speech or the like) with an information processing apparatus in order to perform other tasks such as communicating with other users (e.g. online chat when playing a videogame, for example).

Use of audio for with an information processing apparatus is advantageous as it may enable a user to control the information processing apparatus without using their hands (e.g. without holding an input device). This can improve accessibility of the information processing apparatus. Moreover, it can enable a user to provide audio instructions at the same time as using a different type of input device. For example, a user who is playing a videogame on an entertainment system may be able to use audio in order to chat with other people playing the videogame (e.g. online chat) while still playing the videogame using an input device such as a controller.

However, there is a problem in that it can be difficult for a user to provide audio input in certain situations or environments (e.g. when there is a lot of background noise). Moreover, some users may find it more difficult to provide audio input. Accordingly, it can be difficult for a user to use audio input with an information processing apparatus.

It is an aim of the present disclosure to address or mitigate this problem.

### SUMMARY

A brief summary about the present disclosure is provided hereinafter to provide basic understanding related to certain aspects of the present disclosure.

The disclosure is defined by the independent claims.

Further respective aspects and features of the disclosure are defined in the appended claims.

In accordance with embodiments of the disclosure, errors in speech provided by a user can be more accurately and efficiently corrected, thus enabling the user to more easily control an information processing apparatus when using audio commands. Furthermore, grammatical errors, or other such errors in speech, can be corrected in substantially real time, enabling a user to communicate with others more easily over online communication or when speaking in a foreign language.

It will be appreciated that the present disclosure is not particularly limited to these advantageous technical effects. Other advantageous technical effects will become apparent to the skilled person when reading the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an apparatus according to embodiments of the disclosure;

FIG. 2 illustrates an example of an entertainment system in accordance with embodiments of the disclosure;

FIG. 3 illustrates an example handheld controller in accordance with embodiments of the disclosure;

FIG. 4 illustrates the architecture of an example HMD device in accordance with embodiments of the disclosure;

FIG. 5 illustrates an example configuration of an apparatus according to embodiments of the disclosure;

FIG. 6 illustrates an example of acquiring audio in accordance with embodiments of the disclosure;

FIG. 7 illustrates an example of identifying a target portion in accordance with embodiments of the disclosure;

FIG. 8 illustrates an example of generating corrected audio content in accordance with embodiments of the disclosure; and

FIG. 9 illustrates an example method in accordance with embodiments of the disclosure.

### DESCRIPTION OF THE EMBODIMENTS

The foregoing paragraphs have been provided by way of general introduction, and are not intended to limit the scope of the following claims. The described embodiments, together with further advantages, will be best understood by reference to the following detailed description taken in conjunction with the accompanying drawings (wherein like reference numerals designate identical or corresponding parts throughout the several views).

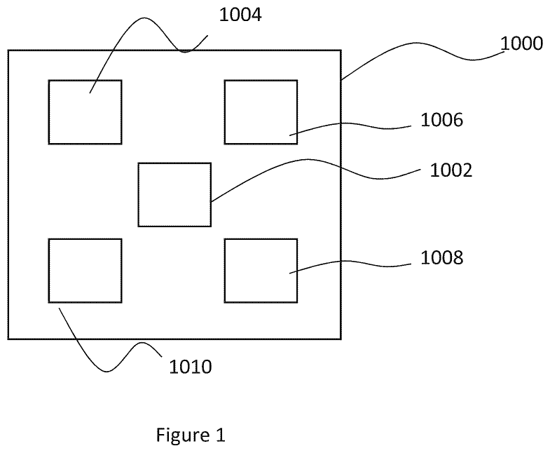

Referring to FIG. 1, an apparatus 1000 (an example of an information processing apparatus) according to embodiments of the disclosure is shown. Typically, an apparatus 1000 according to embodiments of the disclosure is a computer device such as a personal computer, an entertainment system or videogame console such as the Sony® PlayStation 5®, or a terminal connected to a server. Indeed, in embodiments, the apparatus may also be a server. The apparatus 1000 is controlled using a microprocessor or other processing circuitry 1002. In some examples, the apparatus 1000 may be a portable computing device such as a mobile phone, laptop computer or tablet computing device.

The processing circuitry 1002 may be a microprocessor carrying out computer instructions or may be an Application Specific Integrated Circuit. The computer instructions are stored on storage medium 1004 which maybe a magnetically readable medium, optically readable medium or solid state type circuitry. The storage medium 1004 may be integrated into the apparatus 1000 or may be separate to the apparatus 1000 and connected thereto using either a wired or wireless connection. The computer instructions may be embodied as computer software that contains computer readable code which, when loaded onto the processor circuitry 1002, configures the processor circuitry 1002 to perform a method according to embodiments of the disclosure.

Additionally, an optional user input device 1006 is shown connected to the processing circuitry 1002. The user input device 1006 may be a touch screen or may be a mouse or stylist type input device. The user input device 1006 may also be a keyboard, controller, or any combination of these devices. Furthermore, the input device 1006 may be an audio input device such as microphone or the like which can receive audio instructions (sounds, speech or the like) which are provided by the user.

A network connection 1008 may optionally be coupled to the processor circuitry 1002. The network connection 1008 may be a connection to a Local Area Network or a Wide Area Network such as the Internet or a Virtual Private Network or the like. The network connection 1008 may be connected to a server allowing the processor circuitry 1002 to communicate with another apparatus in order to obtain or provide relevant data. The network connection 1002 may be behind a firewall or some other form of network security.

Additionally, shown coupled to the processing circuitry 1002, is a display device 1010. The display device 1010, although shown integrated into the apparatus 1000, may additionally be separate to the apparatus 1000 and may be a monitor or some kind of device allowing the user to visualise the operation of the system (e.g. a display screen or a head mounted display). In addition, the display device 1010 may be a printer, projector or some other device allowing relevant information generated by the apparatus 1000 to be viewed by the user or by a third party.

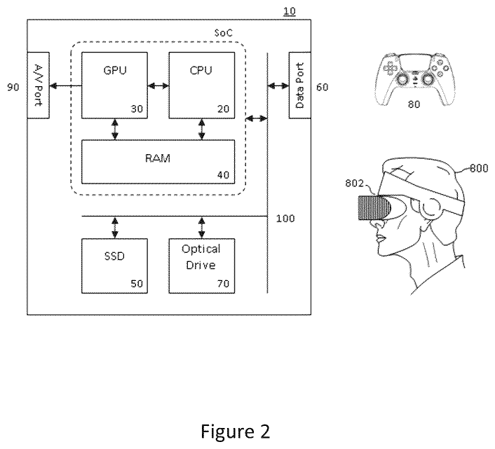

Referring now to FIG. 2, an example of an entertainment system in accordance with embodiments of the disclosure is illustrated. An example of an entertainment system 10 is a computer or console such as the Sony® PlayStation 5® (PS5). The entertainment system 10 is an example of an information processing apparatus 1000 in accordance with embodiments of the disclosure.

The entertainment system 10 comprises a central processor 20. This may be a single or multi core processor, for example comprising eight cores as in the PS5. The entertainment system also comprises a graphical processing unit or GPU 30. The GPU can be physically separate to the CPU, or integrated with the CPU as a system on a chip (SoC) as in the PS5.

The entertainment device also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit or receive data via one or more data ports 60, such as a USB port, Ethernet® port, WiFi® port, Bluetooth® port or similar, as appropriate. It may also optionally receive data via an optical drive 70.

Interaction with the system is typically provided using one or more handheld controllers 80, such as the DualSense® controller in the case of the PS5.

Audio/visual outputs from the entertainment device are typically provided through one or more A/V ports 90, or through one or more of the wired or wireless data ports 60.

Where components are not integrated, they may be connected as appropriate either by a dedicated data link or via a bus 100.

An example of a device for displaying images output by the entertainment system is a head mounted display ‘HMD’ 802, worn by a user 800.

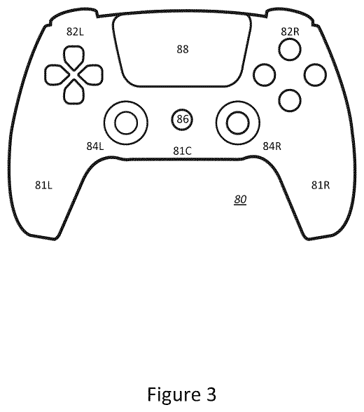

Turning now to FIG. 3 of the present disclosure, an example of a handheld controller in accordance with embodiments of the disclosure is illustrated. Indeed, in FIG. 3, a DualSense® controller 80 is illustrated as an example of a handheld controller. Such a controller typically has two handle sections 81L,R and a central body 81C. Various controls are distributed over the controller, typically in local groups. Examples include a left button group 82L, which may comprise directional controls and/or one or more shoulder buttons, and similarly right button group 82R, which comprise function controls and/or one or more shoulder buttons. The controller also includes left and/or right joysticks 84L,R, which may optionally also be operable as buttons by pressing down on them.

The controller (typically in the central portion of the device) may also comprise one or more system buttons 86, which typically cause interaction with an operating system of the entertainment device rather than with a game or other application currently running on it; such buttons may summon a system menu, or allow for recording or sharing of displayed content. Furthermore, the controller may comprise one or more other elements such as a touchpad 88, a light for optical tracking (not shown), a screen (not shown), haptic feedback elements (not shown), and the like.

It will be appreciated that a head mounted display ‘HMD’, worn by a user, can display images output by the entertainment system.

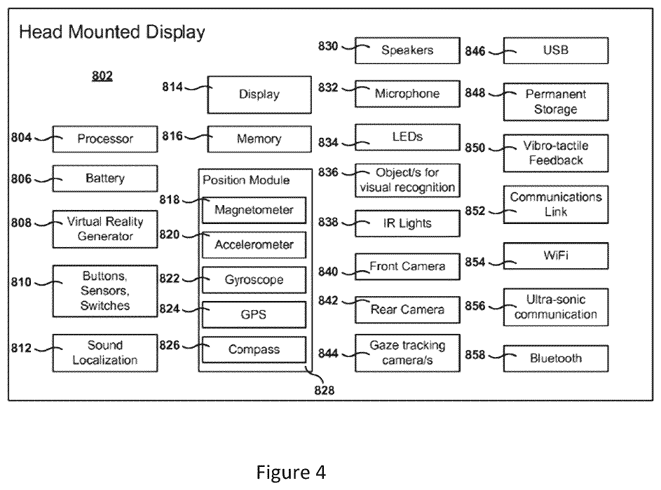

Referring now to FIG. 4, this illustrates the architecture of an example HMD device. The HMD may also be a computing device and may include modules usually found on a computing device, such as one or more of a processor 804, memory 816 (RAM, ROM, etc.), one or more batteries 806 or other power sources, and permanent storage 848 (such as a solid state disk).

One or more communication modules can allow the HMD to exchange information with other portable devices, other computers (e.g. the PS5®), other HMDs, servers, etc. Communication modules can include a Universal Serial Bus (USB) connector 846, a communications link 852 (such as Ethernet®), ultrasonic or infrared communication 856, Bluetooth® 858, and WiFi® 854.

A user interface can include one or more modules for input and output. The input modules can include input buttons (e.g. a power button), sensors and switches 810, a microphone 832, a touch sensitive screen (not shown, that may be used to configure or initialize the HMD), one or more front cameras 840, one or more rear cameras 842, one or more gaze tracking cameras 844. Other input/output devices, such as a keyboard or a mouse, can also be connected to the portable device via communications link, such as USB or Bluetooth®.

The output modules can include the display 814 for rendering images in front of the user's eyes. Some embodiments may include one display, two displays (one for each eye), micro projectors, or other display technologies. Other output modules can include Light-Emitting Diodes (LED) 834 (which may also be used for visual tracking of the HMD), vibro-tactile feedback 850, speakers 830, and a sound localization module 812, which performs sound localization for sounds to be delivered to speakers or headphones. Other output devices, such as headphones, can also connect to the HMD via the communication modules, be permanently attached to the HMD, or integral to it.

One or more elements that may be included to facilitate motion tracking include LEDs 834, one or more objects for visual recognition 836, and infrared lights 838. Alternatively or in addition, the one or more front or rear cameras may facilitate motion tracking based on image motion.

Information from one or more different modules can be used by the position module 828 to calculate the position of the HMD. These modules can include a magnetometer 818, an accelerometer 820, a gyroscope 822, a Global Positioning System (GPS) module 824, and a compass 826. Alternatively or in addition, the position module can analyze image data captured with one or more of the cameras to calculate the position. Further yet, optionally the position module can perform tests to determine the position of the portable device or the position of other devices in the vicinity, such as a WiFi ping test or ultrasound tests.

A virtual reality generator 808 then outputs one or more images corresponding to a virtual or augmented reality environment or elements thereof, using the position calculated by the position module. The virtual reality generator 808 may cooperate with other computing devices (e.g., PS5® or other game console, Internet server, etc.) to generate images for the display module 814. The remote devices may send screen updates or instructions for creating game objects on the screen. Hence the virtual reality generator 808 may be responsible for none, some, or all of the generation of one or more images then presented to the user, and/or may be responsible for any shifting of some or all of one or both images in response to inter-frame motion of the user (e.g. so-called reprojection).

It should be appreciated that the embodiment illustrated in FIG. 4 is an exemplary implementation of an HMD, and other embodiments may utilize different modules, a subset of the modules, or assign related tasks to different modules. The embodiment illustrated in FIG. 4 should therefore not be interpreted to be exclusive or limiting, but rather exemplary or illustrative. It will also be appreciated that the functionality of at least a subset of the modules may be provided by, or in concert with, corresponding modules of the entertainment device (in turn typically provided by a processor of that device operating under suitable software instruction).

Now, it can be difficult for a user to use audio input with an information processing apparatus. This may be because of the environment or situation in which the user is using the information processing apparatus (e.g. a noisy environment, or a situation in which the user is distracted and less able to provide audio input). It can also be because some users may find it more difficult to provide clear and reliable audio input. For example, a person who is suffering from a speech impediment such as a stutter or a stammer may find it more difficult to provide a clear and reliable audio input.

Accordingly, for these reasons (in addition to those reasons described in the Background), an information processing apparatus, information processing method and a computer program are provided in accordance with embodiments of the disclosure.

### Apparatus

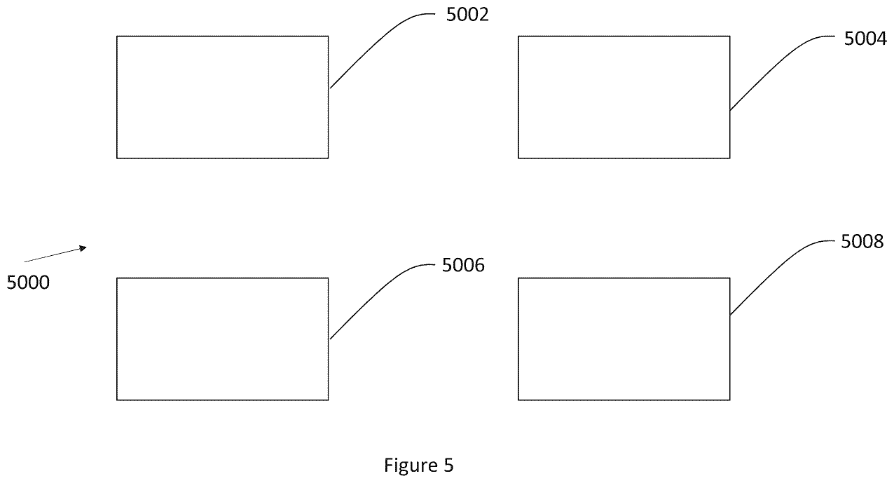

FIG. 5 of the present disclosure illustrates an example configuration of an apparatus in accordance with embodiments of the disclosure.

Apparatus 5000 illustrated in FIG. 5 of the present disclosure comprises an acquiring unit 5002, an identification unit 5004, a selecting unit 5006 and a generating unit 5008.

The acquiring unit 5002 of apparatus 5000 is configured to acquire first audio content from an audio receiving device.

The identification unit 5004 of apparatus 5000 is configured to identify a target portion of the first audio content having a predetermined characteristic.

The selecting unit 5006 of apparatus 5000 is configured to select correction processing to be performed on the target portion of the first audio content in accordance with the predetermined characteristic of the target portion.

Finally, generating unit 5008 of apparatus 5000 is configured to generate corrected audio content in which the target portion of the first audio content has been corrected by performing the selected correction processing on the target portion of the first audio content.

In this manner, errors in a user's audio input (e.g. a repeated or prolonged word or sound) can be efficiently and reliably corrected, thus enabling the user to more easily control an information processing apparatus when using audio commands.

While described as separate units of apparatus 5000, it will be appreciated that the acquiring unit 5002, the identification unit 5004, the selecting unit 5006 and the generating unit 5008 may, more generally, be implemented as circuitry of apparatus 5000 (e.g. processing circuitry 1002 of apparatus 1000 as described with reference to FIG. 1, for example).

Furthermore, in some examples, apparatus 5000 may be part of an entertainment system such as entertainment system 10 described with reference to FIG. 2 of the present disclosure. In particular, one or more of the A/V port 90, GPU 30, CPU 20, RAM 40, SSD 50, Optical Drive 70 and/or Data port 60 of the entertainment system 10 may be configured to function as the apparatus 5000 of the present disclosure. However, the present disclosure is not particularly limited in this regard.

It is further considered that the units 5002, 5004, 5006, and 5008 may be implemented by processing apparatus located at a number of different devices; for instance, the functionality of the apparatus 5000 may be distributed across a number of devices such as an HMD, a games console, and/or a server as appropriate. It is also envisaged that in some embodiments the functionality of a single unit may be provided using a plurality of hardware elements such that two or more processing units located at two or more respective devices each implement a part of the functionality of a particular unit, for example.

Further details of the respective units of the apparatus 5000 will now be described with reference to an example situation where a user is using a playing a videogame on a games console such as entertainment system 10 described with reference to FIG. 2 of the present disclosure. However, while certain features are described in this context, it will be appreciated that such an example is not to be interpreted to be exclusive or limiting, but rather exemplary or illustrative.

### Acquiring Unit

As explained with reference to FIG. 5 of the present disclosure, apparatus 5000 comprises an acquiring unit which is configured to acquire first audio content from an audio receiving device.

The first audio content which is acquired by the acquiring unit may be any sound, speech or the like which is spoken by a user and captured by an audio capture device. The audio capture device may, for example, be a microphone or the like. The acquiring unit 5002 may, in some examples, acquire the first audio content directly from the audio capture device via any suitable wired or wireless connection. Alternatively, the audio content may be acquired from a temporary storage device or memory having been captured by the audio capture device. Indeed, the acquiring unit 5002 may acquire a live buffer of audio from the audio capture device which can be processed by the apparatus 5000 in substantially real time.

The audio content acquired by the acquiring unit 5002 may be in any suitable format, such as a digital representation of the sound or speech which has been spoken by the user. The present disclosure is not particularly limited in this respect.

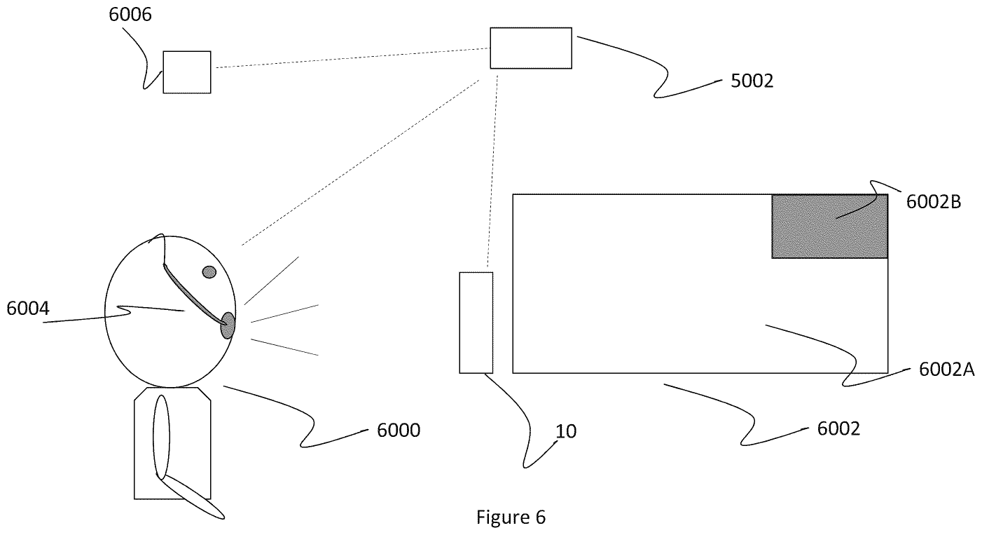

Consider, now, the example of FIG. 6 of the present disclosure. FIG. 6 of the present disclosure illustrates an example situation whereby a user 6000 is playing a videogame on an entertainment system 10. The videogame is displayed to the user on a display device 6002. In this example, the display device is a screen such as a television or a computer monitor. However, the present disclosure is not particularly limited in this respect. In other examples, the videogame may be displayed to the user in a different way such as on a HMD device worn by the user.

In this example, the user is playing a videogame where they can drive a car around a race track. The gameplay is shown to the user on the portion 6002A of the display device 6002. In a second portion of the display device 6002B, the user can see a picture of a player who is playing the videogame on a different entertainment system 10 in a different location. Accordingly, the user 6000 and the other player (who is playing the videogame in a different location) can interact with each other as they are playing the videogame. For example, they may talk to each other about events which occur in the videogame.

The user 6000 may be using an input device such as a controller 80 in order to provide certain input instructions to control the gameplay. For example, the user may press on a joystick such as 84L in order to cause the car in the game to turn around a corner.

However, in this example, the user 6000 who is playing the videogame may also provide one or more input instructions using their voice. In this regard, when the user 6000 speaks a voice instruction, that voice instruction (a type of audio) may be captured by an audio capture device.

In the example of FIG. 6, the audio capture device which captures the voice instruction spoken by the user may be a microphone included in a headset 6004 worn by the user 6000. Alternatively, the audio capture device may be a microphone 6006 located in the environment in which the user is playing the videogame. Indeed, it will be appreciated that the audio capture device which captures the voice instruction issued by the user is not particularly limited in this regard.

In this example, the voice instruction captured by the microphone 6004 or the microphone 6006 is acquired by the acquiring unit 5002. This enables the apparatus 5000 to process the voice instruction which has been issued by the user. Then, when apparatus 5000 has processed the audio content which has been acquired from the microphone 6004 or the microphone 6006, the corrected audio content is passed to the entertainment system 10. Entertainment system 10 can then perform a function or other type of operation in accordance with the corrected audio content.

Accordingly, the user may be able to issue a certain voice instruction to cause the entertainment system 10 to perform a certain function or operation. This may include a voice instruction to cause the entertainment system to pause the videogame. Alternatively, this may include a voice instruction to cause the entertainment system to open a menu within the game. Alternatively, the voice instruction spoken by the user may be an instruction to open a chat function with a player in the portion 6002B of the display screen (e.g. “open chat with player A”). Then, any further voice instructions spoken by the user may be provided to that player as part of the chat (e.g. “good game!”). However, the types of voice instruction which may be provided by the user 6000 is not particularly limited to these examples.

As previously explained, in some environments or situations it may be difficult for a user to provide certain voice instructions. For example, the user may suffer from a certain speech impediment such as a stutter or a stammer. This may cause the user to involuntarily repeat certain sounds, words or syllables. Alternatively, they may involuntarily prolong a certain sound, word or syllable. Certain types of words such as content words including nouns, main verbs, adverbs and adjectives may be more likely to cause a person with a speech impediment to stammer. Alternatively, or in addition, additional words (such as “umm” or the like) may be included in the speech of a person who is suffering from a speech impediment. Speech error from a person suffering from such a speech impediment may make it very difficult for that user to perform voice instructions which can reliably be used to control the entertainment system 10.

The user may also have difficultly pronouncing certain words or phrases. This may be a problem when the user is playing a game in a language other than their native language, for example. This may also be a problem when the user is trying to chat with a different player in a language other than their native language, for example.

Certain environments or situations may also make it more difficult for the user to perform voice instructions. For example, if the user is in a very noisy environment, or in an environment with a lot of distractions, they may find it more difficult to reliably perform the necessary voice instructions. As an example, if the user is distracted while performing a voice instruction, they are more likely to prolong a certain word, sound or syllable.

Errors or inaccuracies in the voice instruction provided by the user may be likely to cause the entertainment system 10 (or any other device which processes those voice instructions) to execute an incorrect function or operation. This can make it very difficult for the user to use voice instructions to control a device such as the entertainment system. Moreover, a person who is suffering from a speech impediment, or who has to communicate in a foreign language may be less comfortable in joining in online communication such as online chat, as they may become embarrassed or frustrated.

However, as the acquiring unit 5002 acquires the voice instruction from the audio capture device before that voice instruction is processed by the entertainment system 10, apparatus 5000 is able to perform certain processing on the voice instruction issued by the user. This enables apparatus 5000 to correct a voice instruction issued by the user before that voice instruction is executed by the entertainment system 10. Therefore, an error in the voice instruction issued by the user can be corrected before that voice instruction is executed by the entertainment system 10, making it easier for a user to use voice instructions when controlling the entertainment system 10.

It will be appreciated that the present disclosure is not particularly limited to the example shown in FIG. 6. For example, the number and type of audio capture devices are not particularly limited to those shown in FIG. 6 of the present disclosure. Indeed, the acquiring unit 5002 of apparatus 5000 may acquire the audio content (first audio content) from any audio capture device which is able to capture sounds generated by the user 6000. Moreover, while the acquiring unit 5002 is shown as being separate from the entertainment system 10, the present disclosure is not particularly limited in this respect. In other examples, at least the acquiring unit 5002 of apparatus 5000 may be a part of the entertainment system 10. In this manner, the acquiring unit acquires first audio content.

### Identification Unit

As explained with reference to FIG. 5 of the present disclosure, apparatus 5000 further includes an identification unit 5004, which is configured to identify a target portion of the first audio content having a predetermined characteristic.

The acquiring unit 5002 of apparatus 5000 acquires the audio content (such as a voice command) when it is spoken by a user. However, there may be examples when the voice command which has been spoken by the user contains certain errors or mistakes. Therefore, the identification unit is configured to analyse the first audio content (the audio content acquired by the acquiring unit 5002) in order to identify a portion or portions of that audio content which contain errors or mistakes. These portions of the audio content are portions of the audio content having a predetermined characteristic.

The predetermined characteristic of the audio content may vary depending on the type of error present in the audio content. For example, when a person suffers from a speech impediment or the like, they may involuntarily repeat a word, prolong a word, or insert an additional word into a voice instruction. Accordingly, when the user has accidentally repeated a certain word, the predetermined characteristic of the content may be a repeated portion of the content. However, when the person has made a mistake by stammering, the predetermined characteristic may also be the presence of a certain word or phrase (such as “umm”) which has been inserted by the user by mistake, or a change in the tempo of the audio (corresponding to the user accidentally prolonging the word).

Accordingly, in embodiments of the disclosure, the predetermined characteristic is a characteristic of the audio content which is indicative of an error or mistake in the audio content.

The identifying unit 5002 of apparatus 5000 is configured to identify these errors within the audio content.

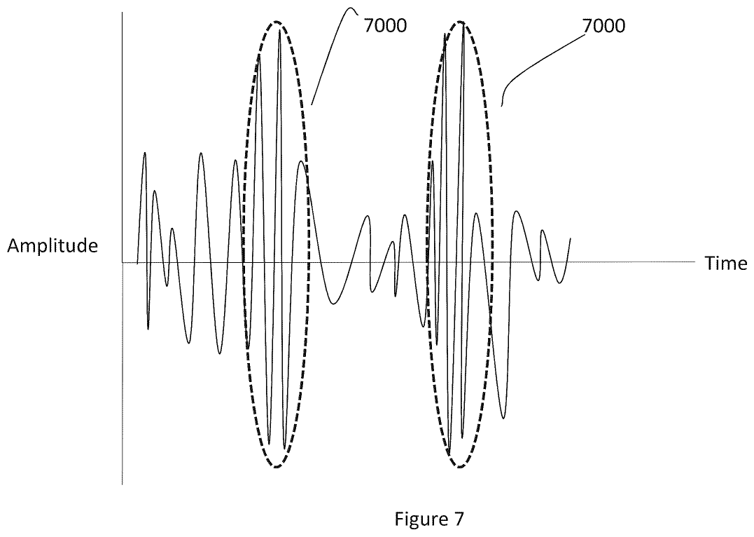

Consider now the example of FIG. 7 of the present disclosure. FIG. 7 illustrates an example of identifying a target portion in accordance with embodiments of the disclosure.

In FIG. 7, an example waveform is shown. The waveform is a type of audio content which may be acquired by the acquiring unit 5002 of apparatus 5000 from a microphone. The amplitude of the sound is recorded on the y-axis. Time is recorded on the x-axis. Therefore, the waveform shows how the amplitude of sound changes over time. Different sounds will have a different waveform.

The audio content which is acquired by the acquiring unit may be in the form of a waveform as shown in FIG. 7 of the present disclosure. However, if the audio content which has been acquired by the acquiring unit 5002 is not in the form of the waveform as shown in FIG. 7 of the present disclosure, then the identification unit 5004 may first convert this audio content into a waveform as shown.

In some examples, the identification unit 5004 of apparatus 5000 may be configured to analyze a waveform such as that illustrated in FIG. 7 of the present disclosure in order to identify whether the waveform has one or more of a set of predetermined characteristics. In this example, the identification unit may identify the sections 7000 as repeated sections of the waveform, as they share a high degree of similarity. Therefore, these sections of the waveform illustrated in FIG. 7 of the present disclosure have the predetermined characteristic that they are repeated sections of the waveform.

The identification unit 5004 may analyze the waveform in any suitable manner in order to identify a target portion of the waveform having the predetermined characteristic. For example, the identification unit 5004 may use signal processing techniques including matched filtering, similarity searching, correlation matrices or the like. However, the present disclosure is not particularly limited in this regard.

It will be appreciated that while the example of FIG. 7 shows the analysis of a waveform in order to identify repeated sections of the waveform, the present disclosure is not particularly limited in this regard. The identification unit 5004 of apparatus 5000 may analyze the waveform of the first audio content as acquired by the first acquiring unit in order to identify a section of the waveform having a different predetermined characteristic (i.e. not merely limited to identification of repeated sections of the waveform). That is, analysis of the waveform may also be used in order to identify portions of the waveform having other predetermined characteristics such as portions of the waveform corresponding to repeated words, prolonged words or the like. Similarly the analysis is not limited to a wave form or other time-series representation but alternatively or in addition my use a frequency or time-frequency based representation such as an audio spectrum, cepstrum, Mel-weighted cepstrum, or the like.

Furthermore, while FIG. 7 of the present disclosure shows an example where the identification unit 5004 of apparatus 5000 analyses the waveform in order to identify a target portion of the first audio content having the predetermined characteristic, the present disclosure is not particularly limited in this regard. The identification unit 5004 may perform any suitable type of analysis on the first audio content in order to identify the portion or portions of the first audio content having the predetermined characteristic as required.

In some examples, the identification unit 5004 may convert the first audio content into text and analysing the text to identify the target portion of the first audio content having the predetermined characteristic.

Consider, again, the example situation described with reference to FIG. 6 of the present disclosure. In this example, a user 6000 is playing a videogame on the entertainment system 10. The user 6000 speaks a voice command which is acquired by the acquiring unit 5002 from the microphone 6004 or the microphone 6006. This first audio content (corresponding to the voice command spoken by the user) is then received by the identification unit 5004 from the acquiring unit 5002.

At this stage, the first audio content (corresponding to the voice command spoken by the user) may be in audio format such as a digital audio format or the like. However, in some examples of the disclosure, the identification unit 5004 may then perform processing in order to convert the first audio content into text. Any suitable speech recognition processing may be performed by the first identification unit 5004 in order to convert the first audio content into text as required. The present disclosure is not particularly limited in this regard. Nevertheless, it will be appreciated that the first identification unit 5004 may convert the audio stream acquired by the acquiring unit (including the first audio content) into text.

Once the first audio content has been converted into text, the identification unit 5004 may further analyse the text in order to identify a portion or portions of the text which have the predetermined characteristic. For example, the identification unit may analyse the text and identify any repeated words in the text. Repeated words then correspond to a portion of the first audio content having the predetermined characteristic of being a repeated portion of the first audio content.

In some examples, the identification unit 5004 may perform a contextual analysis of the audio content in order to verify whether or not a certain feature should be identified as a target portion of the audio content. For example, when a repeated word is identified in the text, the identification unit may analyse whether the repeated word should be permitted in the context in which it is used. Furthermore, in some examples, whether or not use of a repeated word may depend on the actually word itself. In particular, certain repetitions may be acceptable, such as numbers. Therefore, repeated instances of a certain word (such as a number) may not be identified as a target portion of the first audio content having the predetermined characteristic of being a repeated portion of the first audio content.

Alternatively or in addition, the identification unit may analyse the text and search for predetermined audio content such as the word “umm” or any other additional word. Any portions of the text containing these additional words then corresponds to a portion of the first audio content having the predetermined characteristic of containing predetermined audio content.

Alternatively or in addition, the identification unit 5004 may analyse the text and search for grammatical errors within the text. In this manner, any suitable means of performing a grammar check on text may be used in accordance with embodiments of the disclosure. Grammatical errors in the text may then be used in order to quickly and efficiently identify portions of the first audio content having a predetermined characteristic. This is because a person who is finding it difficult to provide a voice command (such as a person who suffers from a speech impediment) may be likely to make certain grammatical errors. For example, a person who suffers from stuttering or stammering may repeat or prolong a word, a syllable, or a consonant or vowel sound. Therefore, by analysing the text, the identification unit 5004 can identify the portions of the first audio content having the predetermined characteristic.

However, the present disclosure is not particularly limited to the process of text-to-speech conversion for the identification of the target portions of the first audio content having the predetermined characteristic. Rather, the identification unit 5004 may perform any suitable type of analysis on the first audio content in order to identify the portion or portions of the first audio content having the predetermined characteristic as required.

In some examples, the identification unit 5004 may be configured perform processing on the audio content acquired by the acquiring unit 5002 in order to generate a frequency spectrum for the audio content. For example, the identification unit 5004 may apply a Fourier transform to the audio content in order to generate a frequency spectrum for the audio content. Then, the identification unit 5002 may identify a target portion of the data having a predetermined characteristic using the frequency spectrum of the audio content. In particular, the identification unit 5002 may identify a portion of the spectrum for which the frequency spectrum displays a certain change in frequency—indicative of a lisp (or similar). This information can then be passed by the identification unit 5002 to the selection unit 5004 for further processing.

In some examples, the identification unit 5004 may be configured perform processing on the audio content acquired by the acquiring unit 5002 in order to evaluate a match (for example of a predetermined command word or phrase) with a template or reference version thereof. This may be achieved for example by cross-correlation of the audio at different time offsets and optionally with different time dilation and compression with the reference. Once a best match is achieved, the identification unit may thus identify leading repetitions of audio that precede the timing for the template, and/or optionally changes in pronunciation/tempo of the audio characterized by the dilation or compression used to achieve the best match.

In some examples, the identification unit 5004 may be configured to identify a target portion of the first audio content having the predetermined characteristic using a trained model.

The trained model may include a machine learning system. Once trained, the machine learning system may then be used in order to identify a portion of the first audio content having a predetermined characteristic.

The machine learning system may be trained on multiple training data sets to identify a portion of the first audio content having the predetermined characteristic. For example, the machine learning system may be trained on a number of training pieces of audio content, in order to identify a portion of the first audio content having the predetermined characteristic. The training pieces of audio content may be historical voice commands spoken by a user. Alternatively, or in addition, the training pieces of audio content may be simulated or synthesized pieces of audio content providing examples of many different types of voice command spoken by a user. Alternatively, or in addition, the training pieces of audio content may be calibration audio content supplied by a user during a calibration phase (in which, the user speaks a number of different voice commands, words or phrases).

In some examples, a deep learning model may be used (as an example of a machine learning system-which is a type of trained model). These deep learning models can be constructed using neural networks. These neural networks may include an input layer and an output layer. A number of hidden layers may be located between the input layer and the output layer. Each layer may include a number of individual nodes. The nodes of the input layer are connected to the nodes of the first hidden layer. The nodes of the first hidden layer (and each subsequent hidden layer) are then connected to the nodes of the following hidden layer. The nodes of the final hidden layer are connected to the nodes of the output layer.

In other words, each of the nodes within a layer connect back to all the nodes in the previous layer of the neural network.

It will be appreciated that both the number of hidden layers used in the model and the number of individual nodes within each layer may be varied in accordance with the size of the training data and the individual requirements in simulating the interactive surgical simulations. As such, the present disclosure is not particularly limited in this respect.

Now, in this example of a neural network, it will be appreciated that each of the nodes takes a number of inputs, and produces an output. The inputs provided to the node (through connections with the previous layers of the neural network) have weighting factors applied to them.

In a neural network, the input layer receives a number of inputs (such as a piece of audio content). These inputs are then processed in the hidden layers, using weights that are adjusted during the training. The output layer then produces a prediction from the neural network (such as an identified portion of the audio content having a predetermined characteristic (e.g. a repeated portion of the audio content, an additional or superfluous piece of the audio content, or the like).

Specifically, during training, the training data may be split into inputs and targets. The input data is all the data except from the target (the identification of the piece of the audio content having the predetermined characteristic). The input data is then analysed by the neural network during training in order to adjust the weights between the respective nodes of the neural network. In examples, the adjustment of the weights during training may be achieved through linear regression models. However, in other examples, non-linear methods may be implemented in order to adjust the weighting between nodes to train the neural network.

Effectively, during training, the weighting factors applied to the nodes of the neural network are adjusted in order to determine the value of the weighting factors which, for the input data provided, produces the best match to the target data. That is, during training, both the inputs and target outputs are provided. The network may then process the inputs and compare the resulting output against the target data (i.e. the identification of the portion of the audio content having the predetermined characteristic). Differences between the output and the target data are then propagated back through the neural network, causing the neural network to adjust the weights of the respective nodes of the neural network.

The number of training cycles (or epochs) which are used in order to train the model may vary in accordance with the particular implementation. In some examples, the model may be continuously trained on the training data until the model produces an output within a predetermined threshold of the target data. Therefore, the present disclosure is not particularly limited to any specific number of training cycles.

Once trained, new input data can then be provided to the input layer of the neural network, which will cause the model to generate (on the basis of the weights applied to each of the nodes of the neural network during training) a predicted output for the given input data. In other words, once trained, new audio content may be provided by the input layer of the neural network, and the model will then generate a prediction of a portion of that new audio content having a predetermined characteristic as an output.

It will be appreciated that the present embodiment is not particularly limited to the deep learning models (such as the neural network) and any such machine learning algorithm can be used in accordance with embodiments of the disclosure depending on the situation.

Accordingly, once trained, the machine learning system (or other trained model) is able to receive audio content as input and produce a prediction of a portion of that audio content having a predetermined characteristic as output.

Use of a trained model to identify a portion of the first audio content having the predetermined characteristic may further improve the accuracy and efficiency with which the relevant portions of the first audio content can be identified.

However, it will be appreciated that the present disclosure is not particularly limited to the use of a trained model for the identification of a portion or portions of the first audio content having the predetermined characteristic. Rather, the identification unit 5004 may perform any suitable type of analysis on the first audio content in order to identify the portion or portions of the first audio content having the predetermined characteristic as required.

When using a trained model to identify the portions of the first audio content having the predetermined characteristic, certain calibration data may be provided by the user in order to assist training of the trained model. However, the use of calibration data is not limited to the example where the identification unit identifies the portions of the first audio content with a trained model. In examples, identifying the target portion of the first audio content having the predetermined characteristic may comprise comparison of the first audio content with calibration data provided by a user. That is, use of the calibration data may be used either as an alternative or in addition to any of the aforementioned types of processing which may be performed by the identification unit 5004 for identification of the portions of the audio content (including, for example, in combination with waveform analysis and/or text-to-speech analysis).

Consider, again, the example of FIG. 6 of the present disclosure. In this example, the user 6000 is playing a videogame on the entertainment system 10. Before playing the videogame, the user may perform an initial calibration phase. During calibration, the display 6002 may display certain words or phrases and ask the user to repeat those words or phrases. This enables the apparatus 5000 to learn how the user 6000 speaks. That is, the user 6000 can provide examples of their speech in order to assist with later identification of portions of audio content having a predetermined characteristic (e.g. by highlighting problems a user has with certain sounds or words).

Apparatus 5000 may then record the examples of the user repeating those calibration words or phrases. These examples of the user repeating the calibration words or phrases can then be used during the analysis performed by the identification unit 5004 in order to more accurately and reliably identify the portions of the audio content.

For example, if the calibration shows that the user often struggles to speak a certain sound, then the identification unit 5004 may focus on that sound when identifying portions of the first audio content.

However, the present disclosure is not particularly limited in this regard. Instead, identification unit 5004 of apparatus 5000 may identify portions of the first audio content having a predetermined characteristic without initial calibration by the user.

In some examples, identifying unit 5004 may further use additional information in combination with analysis of the first audio content in order to identify the target portions of the first audio content. Use of additional information in this manner can further improve the accuracy and reliability of the identification of the target portions of the first audio content.

In some examples, the additional information may be acquired by acquiring unit 5002 from additional data sources such as an image capture device or a sensing device.

Consider an example situation where a person who suffers from a speech impediment such as stuttering or stammering is providing audio content (such as voice commands) in order to control an entertainment system 10. In this example situation, problems with the person's speech may be identified by identifying unit 5004 by analysing the person's speech (e.g. to identify repeated sections of audio). However, a nonverbal action can also occur when stuttering or stammering. This can include tensing or blinking, for example. Nonverbal actions can therefore provide additional markers of a target portion of the first audio content.

As an example, apparatus 5000 may be configured to acquire first image data corresponding to the first audio content from an image capture device; and to identify the target portion of the first audio content having the predetermined characteristic in accordance with the first image data which has been acquired.

The first image data corresponding to the first audio content may be image data (either still image data or video image data) of the user recorded by an image capture device at the time when the user provided the first audio content (e.g. at the time when the user spoke the voice command). Analysis of this image data by identification unit 5004 of apparatus 5000 may then enable identification of a target portion of the audio content (being a portion of the audio content containing an error). For example, image analysis of the image data may show that the user tensed or blinked at a certain moment during the time when the user provided the first audio content. It is likely that this moment corresponds to a time when the user was struggling to provide the first audio content (e.g. a particularly difficult portion of the voice command for the user, which caused the user to stutter or stammer). Identifying unit 5004 can then carefully analyse the corresponding portion of the audio content in order to verify that said portion is a target portion of the audio content and also to identify the type of error (predetermined characteristic) of the audio content.

Combining the use of additional data with the analysis of the first audio content in this manner may further improve the efficiency of identification of the target portions of the first audio content. This is because more detailed analysis of the audio content may be reserved for portions of the content which have been pre-selected based upon the additional information. Moreover, certain cues in the additional information (such as the user tensing or blinking) may show when the user is struggling with the audio content even before the user attempts to speak.

In some examples, the identification unit 5002 may combine a number of different types of analysis in order to identify target portions of the audio content. For example, the identification unit may use waveform analysis in order to identify a stutter, speech-to-text analysis to identify grammatical errors and frequency spectrum analysis to identify a lisp (or similar) in the audio content. Combining different types of processing and analysis of the audio content in this manner may further improve the accuracy and efficiency with which the relevant portions of the audio content can be identified by the identifying unit 5002. However, the present disclosure is not particularly limited to the use of a combination of different types of analysis.

In this manner, the identification unit 5004 of apparatus 5000 is configured to identify a target portion of the first audio content having the predetermined characteristic.

### Selecting Unit

As explained with reference to FIG. 5 of the present disclosure, apparatus 5000 comprises a selecting unit 5006, which is configured to select correction processing to be performed on the target portion of the first audio content in accordance with the predetermined characteristic of the target portion.

It will be appreciated that there are many different types of errors which may be present in the first audio content acquired by the acquiring unit 5002 of apparatus 5000. Moreover, while certain portions of the audio content may have errors, other portions of the audio content may not have errors. As an example, the start of a sentence is particularly difficult for a person with a speech impediment such as stuttering or stammering. However, mid-sentence errors or mispronunciations can also occur. Therefore, when correcting the first audio content which has been acquired, it is important that appropriate types of correction processing are applied to the relevant portions of the audio content.

Accordingly, the selecting unit 5006 receives from the identification unit 5004—either directly or indirectly—information identifying one or more target portions of the audio content. These target portions of the audio content are the portions of the target audio content for which it has been identified that there is an error in the audio content. Moreover, for each of these target portions of the audio content, the selecting unit 5006 receives from the identification unit 5004—either directly or indirectly—information identifying the predetermined characteristic of the first audio content (i.e. information identifying the type of error which is present). The selecting unit 5006 then uses this information in order to select the correction processing to be performed on the target portion of the first audio content.

In some examples, correcting the target portion comprises modifying the target portion such that the target portion does not have the predetermined characteristic. Therefore, the correction processing to be performed must be selected in accordance with the predetermined characteristic of the target portion, in order that appropriate correction processing to remove the predetermined characteristic (the type of error in the target portion) can be performed.

Consider, again, the example described with reference to FIG. 7 of the present disclosure. In this example, there is a repeated portion of the waveform. This may occur because of a stutter or stammer when the user provided the first audio content, for example. Accordingly, the identifying unit has identified the portion 7000 of the waveform as the target portion, and identified the predetermined characteristic of this target portion that the target portion contains a repeated section.

Use of the waveform shown in the example of FIG. 7 of the present disclosure as a voice command to control the entertainment system 10 may be problematic, as the repeated section of the waveform may cause an incorrect function to be performed by the entertainment system. Therefore, apparatus 5000 of the present disclosure is provided to correct the waveform before it is used for a further purpose (such as to control the entertainment system 10).

As the predetermined characteristic is that the target portion contains a repeated section, the selecting unit 5006 of apparatus 5000 must select a type of correction processing to be performed which will be able to correct the error in the waveform. Therefore, in this example, the selecting unit is configured to select correction processing to remove or replace the repeated section of the waveform (and thus remove the predetermined characteristic of the content).

However, the correction processing to be performed is not particularly limited to the removal or replacement of the repeated section of the waveform (this being merely one example of correction processing which can be performed when the predetermined characteristic is a repeated section).

More generally, any suitable correction processing can be selected depending on the predetermined characteristic of the target portion which has been identified by the identifying unit. For example, the correction processing to be performed may, in some examples, comprise at least one of: removal of at least the target portion of the first audio content, replacement of at least the target portion of the first audio content, and/or adaptation of the tempo of at least the target portion of the first audio content.

In some examples, the selecting unit may be configured to select the correction processing by comparing the predetermined characteristic of the target portion with a look-up table associating predetermined characteristics of audio content with correction processing. That is, a look-up table (or other form of database) may be stored in a memory of apparatus 5000 in advance. Alternatively, a look-up table (or other form of database) may be stored in a memory accessible to apparatus 5000 in advance. The look-up table may associate a type of predetermined characteristic of the content with a type of correction processing which should be performed. Then, when that predetermined characteristic is identified by the identifying unit 5006 for a given target portion of the audio, the selecting unit can use the look-up table in order to identify which type of correction processing should be performed. In this way, appropriate correction processing for audio content acquired by the acquiring unit can be selected.

Consider an example situation as described with reference to FIG. 6 of the present disclosure. In this example, a user 6000 is playing a videogame on entertainment system 10. During the game, they are chatting with a friend who is also playing the videogame from a different location. This may be a form of online chat for example. To chat with their friend, the user 6000 speaks into a microphone 6004. The sound recorded by the microphone 6004 is acquired by apparatus 5000 in order to correct for errors before it is transmitted by entertainment system 10 to their friend.

User 6004 may be speaking in a language other than their native language when communicating with their friend over the online chat. Therefore, the user 6000 may make accidental grammatical mistakes when speaking with their friend. Alternatively, the user 6000 may accidentally mispronounce a word or phrase when speaking with their friend during the online chat.

Identifying unit 5004 may identify any errors or mistakes in the audio content received by the microphone 6004. This may include identifying which portions of the audio content have a mistake (the target portions of the audio content) and also the type of mistake which these portions contain.

In this example, the user 6000 may accidentally use the expression, “I am win” as opposed to the grammatically correct expression, “I am winning”. Identifying unit 5004 identifies this mistake and provides the necessary information to the selecting unit 5006 of apparatus 5000. The information indicates the target portion of the expression, “win” and the predetermined characteristic of this target portion—which, in this specific example, is that the target portion contains a grammatical mistake.

At this stage, the selecting unit 5006 can used the information received from the identifying unit 5004 in order to select the type of correction processing which should be performed on the audio content. Here, the selecting unit 5006 selects that replacement processing should be performed in order to correct the audio. That is, in order to correct the audio content, the selecting unit 5006 selects that the target portion “win” of the expression, “I am win” should be replaced with the word/sound “winning”. This may be selected by comparing the predetermined characteristic of the target content (here, a grammatical mistake) with the look-up table, which associates a grammatical mistake with replacement correction processing.

Selecting unit 5006 can then provide the information concerning the type of correction processing which should be performed on the audio content acquired by acquiring unit 5002 from the microphone 6004 to the generating unit 5008 for generation of the corrected audio content.

Accordingly, grammatical errors, or other such errors in speech, can be corrected in substantially real time, enabling a user to communicate with others more easily over online communication or when speaking in a foreign language.

While a look-up table or the like can be used by the selecting unit 5006 in order to select the type of correction processing which should be applied to the first audio content, the present disclosure is not particularly limited in this regard. In some examples, the selecting unit 5006 of apparatus 5000 may be configured in order to select a type of correction processing to be performed using a trained model (such as a machine learning model or the like). The trained model may be trained on a number of training data sets demonstrating the appropriate type of correction processing which should be performed on a certain type of error in the audio content. Then, once trained, the trained model can be used in order to select the best type of correction processing to be performed on the audio content acquired by the acquiring unit 5002.

However, alternatively or in addition, the selecting unit 5006 may select a type of correction processing based on a pre-configured selection made by the user. For example, the user may indicate that if they stutter or stammer when trying to said the sound “o” then repeated instances of the sound “o” should be removed from a voice command or instruction.

Alternatively or in addition, the selecting unit 5006 may select a type of correction processing by comparison of the target portion (and the predetermined characteristic of the target portion) with a dictionary or the like. For example, if, during gameplay a user mistakenly says the phrase “I am win”, the selecting unit may compare the expression with a dictionary or the like in order to identify the correct expression and thus the type of correction processing which must be performed on the target portion in order to correct the audio content.

In this way, correction processing for the first audio content appropriate for the error in that first audio content can be selected by the selecting unit 5006 in accordance with the predetermined characteristic of the target portion.

### Generating Unit

As explained with reference to FIG. 5 of the present disclosure, apparatus 5000 of the present disclosure further comprises a generating unit 5008 configured to generate corrected audio content in which the target portion of the first audio content has been corrected by performing the selected correction processing on the target portion of the first audio content.

By generating a corrected audio content, the error in the first audio content acquired by the acquiring unit 5002 can be removed. Thus enabling the user to more easily control an information processing apparatus when using audio commands, for example.

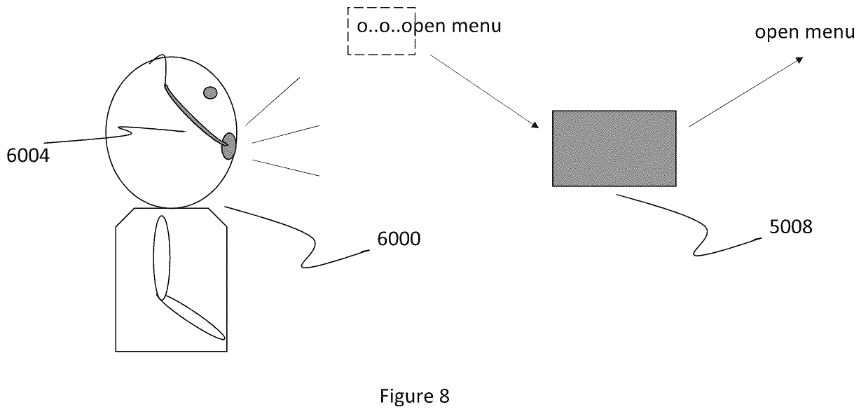

Consider the example of FIG. 8 of the present disclosure. FIG. 8 illustrates an example of generating corrected audio content in accordance with embodiments of the disclosure.

In this example, a user 6000 is playing a videogame on an entertainment system 10 as described with reference to FIG. 2 of the present disclosure. The user 6000 is able to provide audio input to control the entertainment system during the gameplay. For example, the user can provide one or more voice commands in order to control the entertainment system by speaking into the microphone 6004. In this example, the user wishes to provide a voice command to open a menu within the game. The command to open the menu is “open menu”. However, the user 6000 suffers from a speech impediment which makes it more difficult for the user to provide the correct voice command. In particular, in this example, the user 6000 suffers from a stutter or stammer. Accordingly, when they try to perform the instruction to open the menu, they inadvertently repeat the letter “o” as they are trying to say the command “open menu”. Accordingly, the sound that the user 6000 actually speaks into the microphone 6004 is “o . . . o . . . open menu”.

Identifying unit 5004 of apparatus 5000 identifies that there is a repeated portion of the voice command and provides this information concerning the target portion (the repeated portion) and the predetermined characteristic of that portion (the fact the sound “o” is repeated in the target portion) to the selecting unit. The selecting unit 5006 of apparatus 5000 then selects processing which should be performed in order to correct this voice command. The information concerning the correction processing is then passed to the generating unit 5008 of apparatus 5000 in order that the generating unit 5008 can perform the processing on the voice command to remove the error.

In this example, the selecting unit 5006 of apparatus 5000 selects correction processing to trim the voice command and remove the repeated sound “o” as the processing which should be performed by generating unit 5008. On receiving this information, the generating unit then performs the correction processing on the audio content (first audio content) in order to generate the corrected audio content (in which the predetermined characteristic of the first audio content has been removed). Here, in this example, the generating unit 5008 trims the first audio content in order that the corrected audio content is “open menu”. This corrected audio content is then output by the generating unit 5008 whereby it can be used to control the operation of the entertainment system 10—that is, the entertainment system 10 can receive the corrected audio “open menu” (as opposed to the first audio content “o . . . o . . . open menu” as spoken by the user. As the operation is based on the corrected audio content generated by apparatus 5000, the user can more easily control an information processing apparatus when using audio commands.

Alternatively, in an example where the user is using an online chat in order to communicate with a friend, the audio content sent to the friend using the online chat will be the corrected audio content generated by the generating unit 5008. Therefore, even when the user makes an error when speaking, this error will not be transmitted over the online chat. Accordingly, a person with a speech impediment may be more comfortable to join in online communication. Furthermore, a person may be more comfortable to speak in a foreign language which is not their native language, as mispronunciations or grammatical mistakes would be corrected for by the apparatus 5000.

The type of processing performed by the generating unit 5008 to generate the corrected audio content will depend, at least in part, on the type of error which has been identified in the audio content spoken by the user and the corresponding correction processing selected by the selecting unit 5008. However, any suitable signal processing techniques or the like can be applied by the generating unit in order to correct the audio content as required.

In some examples, the generating unit 5008 is configured to replace the target portion of the first audio content with synthesized audio content and/or pre-recorded audio content. The selecting unit 5006 of apparatus 5000 may send an instruction to the generating unit 5008 to instruct the generating unit 5008 to replace the target portion of the first audio content with synthesized audio content and/or pre-recorded audio content when the user has mispronounced a word, for example. That is, if a user mispronounces a specific word (such as “hello”) then the selecting unit 5006 may instruct the generating unit 5008 to replace the portion of the audio content corresponding to the word “hello” as spoken by the user with a synthesized replacement audio content of the word “hello” with the correct pronunciation. The corrected audio content will then comprise the audio content as originally spoken by the user with the mispronounced word being replaced with a synthesized version of that word with the correct pronunciation. The synthesized version of the word may be generated based on certain data provided by the user (e.g. the calibration data) in order to resemble the user's voice.

In some examples, where the user knows they often mispronounce a word, the user may provide an example of their speech which can be recorded and used by apparatus 5000 in order to replace any later mispronunciations of that word. As the word is then replaced with pre-recorded audio content provided by the user, a more natural corrected audio content can be produced using the user's own voice.

Alternatively, in some examples, the correction processing performed by the generating unit 5008 may be performed on text once the audio content has been converted using speech-to-text functions. Then, once the text content has been corrected by generating unit 5008, a text-to-speech function can be performed by the generating unit 5008 in order to generate the corrected audio content.

Once the generating unit 5008 applies the selected processing to the audio content, the audio content is corrected audio content and will no longer have the predetermined characteristic which was identified by the identifying unit. As such, it will be appreciated that the generating unit 5008 applies certain processing to the audio content in accordance with the information provided by the selecting unit 5006 of apparatus 5000 in order to remove the error from the audio content.

Therefore, apparatus 5000 can automatically replace words when the wrong one/a mispronunciation is used, for example.

In some examples, once the corrected audio content has been generated by the generating unit 5008 of apparatus 5000, the generating unit 5008 may perform one or more additional functions or operations using the corrected audio content. For example, in some embodiments o the disclosure the generating unit 5008 of apparatus 5000 is further configured to perform a control operation in accordance with the corrected audio content which has been generated. The control operation is not particularly limited in accordance with embodiments of the disclosure. Nevertheless, it will be appreciated that by using the corrected audio content to perform the control operation, the likelihood of an incorrect control operation being performed is reduced as compared to when the audio content (including errors) is used.

In some examples, the control operation includes one or more of storing the corrected audio content and/or transmitting the corrected audio content. Storing of the corrected audio content enables the corrected audio content to be accessed at a later time as required. Transmitting the corrected audio content enables the corrected audio content to be used by an external device. For example, the corrected audio content could be transmitted to an entertainment system 10 for use once it has been generated by the generating unit 5008 of apparatus 5000.

Furthermore, in some examples, the apparatus 5000 may control the operations of the entertainment system in accordance with the corrected audio content. In this situation, the apparatus 5000 may send the result of the processing performed based on the corrected audio content to the entertainment system 10 (e.g. an instruction to open the menu) as opposed to sending the corrected audio content (e.g. “open menu”) to the entertainment system 10. This may be particularly advantageous to reduce the transmission overheads between the apparatus 5000 and the entertainment system 10.

Consider, now, an example situation described with reference to FIG. 6 of the present disclosure. In this example, a user 6000 is playing a videogame on an entertainment system 10. While playing the videogame, the user is engaged in an online chat with a friend who is also playing the videogame in a different location. The online chat is displayed in a section 6002B of the display. However, in this example situation, an avatar of the user appears in the section 6002B of the display. The avatar of the user may be an avatar online of the user's face. This enables the user to choose how they are visually represented during the online chat. In some examples, apparatus 5000 is configured to perform processing on the avatar of the user in order to update the appearance of the avatar of the user in accordance with the corrected audio content. For example, apparatus 5000 may be configured to move the mouth of the avatar of the user in accordance with the corrected audio content. Therefore, even if the user makes an error in the speech, the appearance of the avatar does not reflect this error. Instead, the movement of the avatar's mouth can be adapted to match the change in the audio content which is made when the generating unit 5008 corrects the audio content.

While the correction of the movement of the mouth of the avatar is described with reference to an online chat, the present disclosure is not particularly limited in this regard. Instead, the audio content generated by the generating unit 5008 can be used in order to move the mouth of the avatar of the user in any situation where the user is represented by an avatar.

In this way, the generating unit 5008 is configured to generate corrected audio content in which the target portion of the first audio content has been corrected by performing the selected correction processing on the target portion of the first audio content.

### Advantageous Technical Effects

In accordance with embodiments of the disclosure, errors in a user's audio input (e.g. a repeated or prolonged word or sound) can be efficiently and reliably corrected, thus enabling the user to more easily control an information processing apparatus when using audio commands. Furthermore, grammatical errors, or other such errors in speech, can be corrected in substantially real time, enabling a user to communicate with others more easily over online communication or when speaking in a foreign language.

The present disclosure is not particularly limited to these advantageous technical effects. Other technical effects may become apparent to the skilled person when reading the disclosure.

### Method

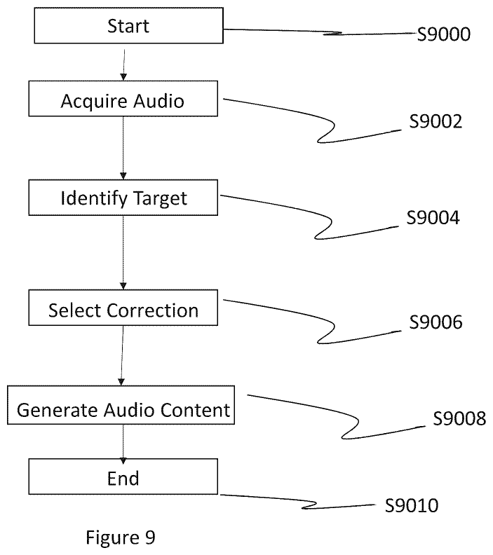

Hence, more generally, an information processing method is provided in accordance with embodiments of the disclosure. FIG. 9 illustrates an example method in accordance with embodiments of the disclosure. This method may be performed by an information processing apparatus such as apparatus 5000 described with reference to FIG. 5 of the present disclosure. Alternatively, this method may be performed by an apparatus such as apparatus 1000 described with reference to FIG. 1 of the present disclosure.

The method starts at step S9000, and proceeds to step S9002. In step S9002, the method comprises acquiring first audio content from an audio receiving device. Then, the method proceeds to step S9004. In step S9004, the method comprises identifying a target portion of the first audio content having a predetermined characteristic. Then, the method proceeds to step S9006. In step S9006, the method comprises selecting correction processing to be performed on the target portion of the first audio content in accordance with the predetermined characteristic of the target portion. The method then proceeds to step S9008. In step S9008, the method comprises generating corrected audio content in which the target portion of the first audio content has been corrected by performing the selected correction processing on the target portion of the first audio content. The method then proceeds to and ends with step S9010.

While the example method of FIG. 9 is shown in a sequence of steps, it will be appreciated that the present disclosure is not particularly limited in this regard. A number of the steps of the method may, alternatively, be performed in parallel.

While certain embodiments of the disclosure have been described with reference to the example situation of use of audio input with an entertainment system (such as entertainment system 10 described with reference to FIG. 2 of the present disclosure) it will be appreciated that the present disclosure is not particularly limited in this respect. Embodiments of the disclosure may, more generally, be applied to the use of an information processing apparatus in any environment or situation including in a hospital, in an office or in a vehicle, for example.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units, or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

Embodiments of the present disclosure may be implemented in accordance with any one or more of the following numbered clauses:

1. An information processing method of generating corrected audio content in which a portion of first audio content has been corrected, the method comprising: acquiring first audio content from an audio receiving device; identifying a target portion of the first audio content having a predetermined characteristic; selecting correction processing to be performed on the target portion of the first audio content in accordance with the predetermined characteristic of the target portion; and generating corrected audio content in which the target portion of the first audio content has been corrected by performing the selected correction processing on the target portion of the first audio content.

2. The information processing method of clause 1, wherein the predetermined characteristic of the first audio content comprises at least one of: a repeated audio content, a predetermined audio content, and/or audio content having a tempo below a predetermined threshold value.

3. The information processing method of clause 2, wherein when the audio content is at least one of: a word, a syllable, a consonant, and/or a vowel.

4. The information processing method of clauses 1 to 3, wherein the method comprises identifying the target portion of the first audio content having the predetermined characteristic by analysing a waveform of the first audio content; or wherein the method comprises converting the first audio content into text and analysing the text to identify the target portion of the first audio content having the predetermined characteristic; or wherein identifying the target portion of the first audio content having the predetermined characteristic comprises use of a trained model.

5. The information processing method of clauses 1 to 4, wherein identifying the target portion of the first audio content having the predetermined characteristic comprises comparison of the first audio content with calibration data provided by a user.

6. The information processing method of clauses 1 to 5, wherein the method further comprises acquiring first image data of the user corresponding to the first audio content from an image capture device; and identifying the target portion of the first audio content having the predetermined characteristic in accordance with the first image data which has been acquired.

7. The information processing method of clauses 1 to 6, wherein the correction processing to be performed comprises at least one of: removal of at least the target portion of the first audio content, replacement of at least the target portion of the first audio content, and/or adaptation of the tempo of at least the target portion of the first audio content.

8. The information processing method of clause 7, wherein the method comprises replacing the target portion of the first audio content with synthesized audio content and/or pre-recorded audio content.

9. The information processing method of clauses 1 to 8, wherein the method comprises selecting the correction processing by comparing the predetermined characteristic of the target portion with a look-up table associating predetermined characteristics of audio content with correction processing.

10. The information processing method of clauses 1 to 9, wherein the method further comprises performing a control operation in accordance with the corrected audio content which has been generated.

11. The information processing method of clause 10, wherein the control operation includes one or more of: storing and/or transmitting the corrected audio content.

12. The information processing method of clause 10, wherein an avatar of a user is displayed and performing the control operation comprises controlling an appearance of the avatar of the user in accordance with the corrected audio content.

13. An apparatus for generating replacement audio content in which a predetermined characteristic of first audio content has been corrected, the apparatus comprising: an acquiring unit configured to acquire first audio content from an audio receiving device; an identification unit configured to identify a target portion of the first audio content having a predetermined characteristic; a selecting unit configured to select correction processing to be performed on the target portion of the first audio content in accordance with the predetermined characteristic of the target portion; and a generating unit configured to generate corrected audio content in which the target portion of the first audio content has been corrected by performing the selected correction processing on the target portion of the first audio content.

14. A computer program comprising instructions which, when implemented by the computer, cause the computer to: acquire first audio content from an audio receiving device; identify a target portion of the first audio content having a predetermined characteristic; select correction processing to be performed on the target portion of the first audio content in accordance with the predetermined characteristic of the target portion; and generate corrected audio content in which the target portion of the first audio content has been corrected by performing the selected correction processing on the target portion of the first audio content.

15. A non-transient computer readable storage medium comprising the computer program according to clause 14.

1. An information processing method of generating corrected audio content in which a portion of first audio content has been corrected, the method comprising:
acquiring first audio content from an audio receiving device;
identifying a target portion of the first audio content having a predetermined characteristic;
selecting correction processing to be performed on the target portion of the first audio content in accordance with the predetermined characteristic of the target portion; and
generating corrected audio content in which the target portion of the first audio content has been corrected by performing the selected correction processing on the target portion of the first audio content.

2. The information processing method of claim 1, wherein the predetermined characteristic of the first audio content comprises at least one of: a repeated audio content, a predetermined audio content, and/or audio content having a tempo below a predetermined threshold value.

3. The information processing method of claim 2, wherein when the audio content is at least one of: a word, a syllable, a consonant, and/or a vowel.

4. The information processing method of claim 1, wherein the method comprises identifying the target portion of the first audio content having the predetermined characteristic by analysing a waveform of the first audio content; or
wherein the method comprises converting the first audio content into text and analysing the text to identify the target portion of the first audio content having the predetermined characteristic; or
wherein identifying the target portion of the first audio content having the predetermined characteristic comprises use of a trained model.

5. The information processing method of claim 1, wherein identifying the target portion of the first audio content having the predetermined characteristic comprises comparison of the first audio content with calibration data provided by a user.

6. The information processing method of claim 1, wherein the method further comprises acquiring first image data of the user corresponding to the first audio content from an image capture device; and identifying the target portion of the first audio content having the predetermined characteristic in accordance with the first image data which has been acquired.

7. The information processing method of claim 1, wherein the correction processing to be performed comprises at least one of: removal of at least the target portion of the first audio content, replacement of at least the target portion of the first audio content, and/or adaptation of the tempo of at least the target portion of the first audio content.

8. The information processing method of claim 7, wherein the method comprises replacing the target portion of the first audio content with synthesized audio content and/or pre-recorded audio content.

9. The information processing method of claim 1, wherein the method comprises selecting the correction processing by comparing the predetermined characteristic of the target portion with a look-up table associating predetermined characteristics of audio content with correction processing.

10. The information processing method of claim 1, wherein the method further comprises performing a control operation in accordance with the corrected audio content which has been generated.

11. The information processing method of claim 10, wherein the control operation includes one or more of: storing and/or transmitting the corrected audio content.

12. The information processing method of claim 10, wherein an avatar of a user is displayed and performing the control operation comprises controlling an appearance of the avatar of the user in accordance with the corrected audio content.

13. An apparatus for generating replacement audio content in which a predetermined characteristic of first audio content has been corrected, the apparatus comprising:
an acquiring unit configured to acquire first audio content from an audio receiving device;
an identification unit configured to identify a target portion of the first audio content having a predetermined characteristic;
a selecting unit configured to select correction processing to be performed on the target portion of the first audio content in accordance with the predetermined characteristic of the target portion; and
a generating unit configured to generate corrected audio content in which the target portion of the first audio content has been corrected by performing the selected correction processing on the target portion of the first audio content.

14. A non-transitory machine-readable storage medium which stores computer software which, when executed by a computer, causes the computer to perform a method for generating corrected audio content in which a portion of first audio content has been corrected, the method comprising:
acquiring first audio content from an audio receiving device;
identifying a target portion of the first audio content having a predetermined characteristic;
selecting correction processing to be performed on the target portion of the first audio content in accordance with the predetermined characteristic of the target portion; and
generating corrected audio content in which the target portion of the first audio content has been corrected by performing the selected correction processing on the target portion of the first audio content.
